(19) United States
(12) Patent Application Publication
(10) Pub. No.: US 2009/0297078 A1
(43) Pub. Date: Dec. 3, 2009

(54) FLUID BEARING DEVICE

(75) Inventors: Masaharu Hori, Kuwana-shi (JP); Masaaki Toda, Kuwana-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NTN CORPORATION, Osaka-shi, Osaka (JP)

(21) Appl. No.: 12/158,408

(22) PCT Filed: Dec. 18, 2006
(86) PCT No.: PCT/JP2006/325175

§ 371 Date: Jun. 20, 2008

(30) Foreign Application Priority Data
Dec. 22, 2005 (JP) 2005-370607
Jan. 19, 2006 (JP) 2006-011565

(51) Int. Cl. F16C 32/06

(52) U.S. Cl. 384/107; 384/114

(57) ABSTRACT

[Problems] Provided is a fluid bearing device in which bearing sleeves are positioned and fixed with respect to a housing with high accuracy.

[Solving Means] To an inner periphery of a housing (7), a first bearing sleeve (8) and a second bearing sleeve (9) are fixed while being spaced apart in an axial direction. Between the bearing sleeves (8) and (9), a spacer (10) made of a resin is disposed. An axial rigidity of the spacer (10) is smaller than those of the first bearing sleeve (8) and the second bearing sleeve (9). Accordingly, in a state where the first bearing sleeve (8) and the second bearing sleeve (9) are positioned and fixed with respect to the housing (7), the spacer (10) is largely compressed in an axial direction compared to the bearing sleeves (8) and (9).

### TECHNICAL FIELD

The present invention relates to a fluid bearing device.

### BACKGROUND ART

The fluid bearing device relatively rotatably supports a shaft member by a lubricating film of a fluid caused in a bearing clearance. Recently, by taking advantage of its excellent rotational accuracy, high-speed rotation property, quietness, and the like, the fluid bearing device is used, for example, as a bearing for a spindle motor mounted on information equipment including magnetic disk devices such as HDD and FDD, optical disk devices such as CD-ROM, CD-R/RW, and DVD-ROM/RAM, and magneto-optical disk devices such as MD and MO, and as a bearing for small motors such as a polygon scanner motor for a laser beam printer (LBP), a color wheel motor for a projector, or a fan motor.

For example, as a fluid bearing device incorporated in the spindle motor for an HDD, there is known one having a structure in which both a radial bearing portion for supporting the shaft member in a radial direction and a thrust bearing portion for supporting the shaft member in a thrust direction are structured by a dynamic pressure bearing including a dynamic pressure generating portion for generating a dynamic action of a lubricating fluid in a bearing clearance. In this case, in one of an inner peripheral surface of a bearing sleeve and an outer peripheral surface of the shaft member opposed thereto, dynamic pressure generating grooves serving as the dynamic pressure generating portion are formed, and the radial bearing portion is formed in a radial bearing clearance therebetween in most cases. Further, in one of one end surface of a flange portion provided to the shaft member and an end surface of the bearing sleeve opposed thereto, the dynamic pressure generating grooves are formed, and the thrust bearing portion is formed in a thrust bearing clearance between those surfaces in most cases (see, for example, Patent Document 1).

Normally, the bearing sleeve of this type is fixed to a predetermined position on an inner periphery of a housing. In this case, as the bearing sleeve fixed to the housing, there are known one having a plurality of dynamic pressure generating grooves constituting regions provided at two positions at an interval in an axial direction on an inner periphery of the one bearing sleeve (see Patent Documents 1 and 2), and one having a plurality of bearing sleeves arranged at the intervals in an axial direction for a purpose of widening a bearing span of the radial bearing portion. In this case, spacers are often interposed between the plurality of bearing sleeves (also referred to as filler pieces) (see, for example, Patent Document 3).

As described above, in the case of using the plurality of bearing sleeves, position accuracy (such as coaxiality) between the bearing sleeves and assembly accuracy of the bearing sleeves with respect to the housing are issues to be considered. For example, in a case of forming thrust bearing clearances between end surfaces of the bearing sleeves and surfaces opposed thereto (such as end surfaces of flange portions), it is necessary that axial positions of the bearing sleeves with respect to the housing be accurately determined. However, in the fluid bearing device having a structure including a spacer interposed between the bearing sleeves, it is not easy to accurately perform the positioning fixation of this kind.

That is, each of the bearing sleeves or the spacer has a dimensional tolerance. Accordingly, in a case where there is an attempt of fixing the bearing sleeves and the spacer to the inner periphery of the housing with those being brought into abutment against each other in the axial direction, there is a possibility in that fixing positions of the bearing sleeves with respect to the housing are shifted in the axial direction from predetermined positions by being affected by variations in axial dimension of the components. The thrust bearing clearance is normally of the order of several μm to several tens of μm. In a case where a total sum of dimensional tolerances of the above-mentioned components is equal to or larger than requisite widths of the thrust bearing clearances, it is difficult to manage the thrust bearing clearances with high accuracy.

Further, for example, in the spindle motor described above, along with increase or the like of information processing amount, lamination, higher speed rotation, and the like of recording mediums are under development. Along with the development, regarding the fluid bearing device mounted to the spindle motor, further increase in bearing rigidity, and in particular, increase in rigidity (moment rigidity) with respect to a moment load are demanded.

As means for increasing the moment rigidity of the fluid bearing device, there may be employed a structure in which the radial bearing surfaces are provided at two positions in the axial direction at an interval, thereby extending an interval distance (bearing span) between the radial bearing portions. As a fluid bearing device having this structure, as described above, there is known one in which the radial bearing portions are formed at an interval in two upper and lower positions of the radial bearing clearances each formed between the inner peripheral surface of each of the bearing sleeves and the outer peripheral surface of the shaft to be supported (see Patent Documents 1 and 2).

However, with this structure, along with enlargement of the bearing span, it is necessary to elongate and enlarge the bearing sleeves. When the bearing sleeves are elongated and enlarged, it is difficult to ensure finishing accuracy of the bearing sleeves. In particular, when the bearing sleeves are made of sintered metal, uniform density thereof cannot be easily obtained at a time of powder compaction thereof, so there is a risk in that desired bearing performance cannot be exerted. Accordingly, there is a limit for further enlargement of the bearing span.

The above-mentioned problems may be solved by realizing a structure in which, as illustrated in FIG. 13(a), two bearing sleeves 102 and 103 are arranged in the axial direction, and radial bearing portions 104 and 105 are formed in the radial bearing clearances between the first bearing sleeve 102 and a shaft member 100 and between the second bearing sleeve 103 and the shaft member 100, respectively. Further, as illustrated in FIG. 13(b), for example, there may be employed a structure in which a member (spacer member) 106 separate from the bearing sleeves is interposed between both the bearing sleeves 102 and 103. Note that, in the structure illustrated in FIG. 13(a), the first bearing sleeve 102 and the second bearing sleeve 103 are allowed to abut on each other at opposing end surfaces thereof. In the structure illustrated in FIG. 13(b), each of the bearing sleeves 102 and 103 and the spacer member 106 are allowed to abut on each other at opposing end surfaces thereof.

For example, in the structure illustrated in FIG. 13(a), both the bearing sleeves 102 and 103 are fixed to an inner periphery of a housing 101 disposed on an outer diameter side of those. The fixation of the bearing sleeves 102 and 103 with respect to the inner periphery of the housing 101 is performed by charging an adhesive into adhesion clearances provided between the inner peripheral surface of the housing 101 and the outer peripheral surfaces of both the bearing sleeves 102 and 103 and solidifying the adhesive (adhesive fixation).

Meanwhile, as illustrated in FIG. 13(a), in the structure in which the end surfaces of both the bearing sleeves abut on each other, owing to variations or the like in molding accuracy and assembling accuracy, a slight axial clearance is formed between the end surfaces of both the bearing sleeves in some cases. When a width of the axial clearance is smaller than a width of each of the adhesion clearances, the adhesive charged into the adhesion clearances at the time of adhesive fixation is led into the radial clearances by a capillary force, and there is a risk in that the adhesive enters and is solidified in an inner diameter side of the bearing sleeves (radial bearing clearances), thereby affecting the bearing performance. Further, depending on an assembling procedure for the bearing sleeves or a charging method for the adhesive, the same problems are induced in some cases.

The above-mentioned problems may also occur in the fluid bearing device of the structure illustrated in FIG. 13(b).

Patent Document 1: JP 2003-239951 A

Patent Document 2: JP 10-9250 A

Patent Document 3: JP 11-155254 A

### DISCLOSURE OF THE INVENTION

### Problems to be Solved by the Invention

It is an object of the present invention to provide a fluid bearing device in which a bearing sleeve is positioned and fixed with respect to a housing with high accuracy.

It is another object of the present invention to provide a fluid bearing device in which the above-mentioned problems at a time of adhesive fixation of the bearing sleeves are avoided, thereby making it possible to exert desired bearing performance.

### Means for Solving the Problems

In order to achieve the above-mentioned objects, the present invention provides a fluid bearing device including: a housing; a plurality of bearing sleeves arranged at an interval in an axial direction on an inner periphery of the housing; a spacer disposed between the bearing sleeves; a shaft member inserted into inner peripheries of the bearing sleeves; and radial bearing portions for relatively rotatably supporting the shaft member by a lubricating film of a fluid, which is generated in radial bearing clearances between an outer peripheral surface of the shaft member and inner peripheral surfaces of the bearing sleeves, in which the bearing sleeves are fixed to the housing with the spacer being compressed and deformed in the axial direction. Herein, the compression deformation of the spacer includes a case involving plastic deformation in addition to elastic deformation.

As described above, when the bearing sleeve is fixed to the housing with the spacer being compressed and deformed in the axial direction, even in a case where axial dimensions of the bearing sleeves each are various, adverse effects of the variations can be reduced by the compression deformation of the spacer. Accordingly, in a state of an assembled body in which the bearing sleeves are fixed to the housing, the variation in axial dimension can be suppressed to small, so positioning and fixation of the bearing sleeves with respect to the housing can be performed with high accuracy.

It is preferable that the spacer can be compressed and deformed depending on a level of the variation in axial dimension of the bearing sleeves. Further, it is preferable that the compression deformation of the spacer be caused by a load of such a level that reduction in accuracy of the bearing sleeve shape can be ignored. In the above-mentioned viewpoints, the compression deformation amount is preferably adjusted by an axial rigidity and an axial dimension of the spacer. For example, in a case where a material is limited, it is preferable that the axial dimension of the spacer be adjusted. On the other hand, in a case where the axial dimension is limited, it is preferable that the material thereof be appropriately selected.

Further, as the spacer, it suffices that the above-mentioned conditions be satisfied, and one having the high dimensional accuracy is not required. Further, there is no need of fixing the spacer to the housing. Accordingly, a molding cost of the spacer can be suppressed to low, and an operation of fixing the bearing sleeves with respect to the housing can be simplified. As a material satisfying those conditions, for example, a material including a resin, rubber, or the like can be suitably used. However, other than that, as long as the material satisfies the above-mentioned conditions, there may be used a sintered porous body, a porous resin, or the like made of a material which is relatively easily compressed and deformed.

As a method of fixing the bearing sleeve, there may be considered various methods such as press fitting or adhesion. However, of those, fixation by adhesion is preferable in the viewpoint that necessity for accuracy of a radial dimension of the bearing sleeve is not required that much (manufacture can be performed roughly to some degree), thereby enabling cost reduction.

In a case where a flange portion protruding radially outwardly is provided to the shaft member, a thrust bearing clearance can be formed between an end surface of the flange portion and the end surface of the bearing sleeve opposed thereto. In particular, the above-mentioned flange portions are provided in two positions on the shaft member, and each of the end surfaces of the flange portions is opposed to each of the end surfaces on a side opposite to the spacer side of the bearing sleeves fixed at an interval in an axial direction. In a case where the thrust bearing clearances are provided between those opposing surfaces, the thrust bearing clearances can be managed with high accuracy, thereby being preferable.

Further, in the case where the shaft member is provided with the flange portion, between the outer peripheral surface of the flange portion and the surface opposed thereto, a seal space for preventing outflow of the fluid inside the housing may be formed.

Further, in order to achieve the above-mentioned objects, the present invention provides a fluid bearing device including: a housing; bearing sleeves arranged at a plurality of positions in an axial direction on an inner periphery of the housing; and radial bearing portions for supporting relatively rotatably in a radial direction a shaft to be supported, by a lubricating film of a fluid, which is generated in radial bearing clearances opposed to inner peripheral surfaces of the bearing sleeves, in which: the bearing sleeves are fixed to the inner periphery of the housing by an adhesive charged into an adhesion clearance provided to an outer periphery of each of the bearing sleeves; and the fluid bearing device further includes a space portion which is provided between the adjacent two bearing sleeves, and which has a width larger than that of the adhesion clearance.

Further, in order to achieve the above-mentioned objects, the present invention provides a fluid bearing device including: a housing; bearing sleeves arranged at a plurality of positions in an axial direction on an inner periphery of the housing; a spacer member disposed between the adjacent two bearing sleeves; and radial bearing portions for supporting relatively rotatably in a radial direction a shaft to be supported, by a lubricating film of a fluid, which is generated in a radial bearing clearances opposed to inner peripheral surfaces of the bearing sleeves, in which: the bearing sleeves and the spacer member are fixed to the inner periphery of the housing by an adhesive charged into an adhesion clearance provided to an outer periphery of each of the bearing sleeves; and the fluid bearing device further includes space portions each of which is provided between each of the bearing sleeves and the spacer member adjacent to each other, and each of which has a width larger than that of the adhesion clearance.

When, like in the above-mentioned structure, the width of the space portion formed between the two bearing sleeves adjacent in the axial direction or between each of the bearing sleeves and the spacer member adjacent in the axial direction is set to be larger than the adhesion clearance, the capillary force is not generated in the space portion or the capillary force in the space portion is smaller than the capillary force in the adhesion clearance. Accordingly, at the time of adhesive fixation, the adhesive charged in the adhesion clearance is led into the space portion, by extension, a phenomenon of the adhesive entering the inner diameter side of the bearing sleeve is prevented. Note that, depending on an assembling method or procedure, the adhesive runs into the space portion at the time of adhesive fixation in some cases. The adhesive running into the space portion side is returned to the adhesive clearance by the capillary force generated in the adhesive clearance, or is retained within a range of the space portion. Owing to a synergistic effect of those, entering of the adhesive to the inner diameter side of the bearing sleeve can be reliably prevented. Accordingly, it is possible to provide the fluid bearing device capable of exerting the desired bearing performance.

The fluid bearing device structured as described above, may further include thrust bearing portions for supporting relatively rotatably in a thrust direction the shaft to be supported, by the lubricating film of the fluid, which is generated in thrust bearing clearances opposed to surfaces of the bearing sleeves opposite to surfaces opposed to the space portion.

The fluid bearing device structured as described above can be preferably used for a motor including the fluid bearing device, a stator coil, and a rotor magnet, specifically, a motor requiring particularly high moment rigidity due to higher speed rotation or a heavier rotator, for example, a spindle motor to which a plurality of disks are to be mounted in which disk-like recording media are stacked.

### EFFECTS OF THE INVENTION

As described above, the present invention can provide a fluid bearing device in which the bearing sleeves are positioned and fixed with respect to the housing with high accuracy.

Further, according to the present invention, it is possible to prevent entering of the adhesive to the inner diameter side of the sleeve which is a problem in adhering and fixing the bearing sleeves to the inner periphery of the housing. As a result, it is possible to provide a fluid bearing device capable of exerting the desired bearing performance and having high moment rigidity.

### BEST MODE FOR CARRYING OUT THE INVENTION

First, a description is made of a first embodiment of the present invention with reference to FIGS. 1 to 5.

FIG. 1 conceptually illustrates a structural example of a spindle motor for information equipment according to a first embodiment of the present invention, in which a fluid bearing device (dynamic pressure bearing device) 1 is incorporated. The spindle motor is used for a disk drive device such as an HDD. The spindle motor includes a fluid bearing device 1 for rotatably supporting a shaft member 2, a hub 3 fixed to the shaft member 2, a stator coil 4 and a rotor magnet 5 opposed to each other through intermediation of a radial gap, for example, and a bracket 6. The stator coil 4 is mounted to an outer periphery of the bracket 6. The rotor magnet 5 is mounted to an inner periphery of the hub 3. The fluid bearing device 1 is fixed to an inner periphery of the bracket 6. The hub 3 holds one or a plurality of (two in FIG. 1) disks D serving as information recording media. In the spindle motor structured as described above, when the stator coil 4 is energized, the rotor magnet 5 rotates owing to an electromagnetic force generated between the stator coil 4 and the rotor magnet 5, thereby allowing the hub 3 and the disk D held by the hub 3 to integrally rotate with the shaft member 2.

FIG. 2 illustrates the fluid bearing device 1. The fluid bearing device 1 includes a housing 7, a first bearing sleeve 8 and a second bearing sleeve 9 which are fixed to an inner periphery of the housing 7, a spacer 10 disposed between the bearing sleeves 8 and 9, and the shaft member 2 inserted into inner peripheries of the first bearing sleeve 8 and the second bearing sleeve 9 and provided with a first flange portion 11 and a second flange portion 12 spaced apart from each other in an axial direction. Note that, for a convenience of description, the description is made with a side of the bearing member 2, on which a fixation side end portion of the hub 3 protrudes, being an upper side, and a side opposite to the protruding side of the shaft member 2 being a lower side.

The housing 7 has a cylindrical shape having openings at both ends thereof, and is formed by shaving metal (including alloy) such as brass or aluminum, or by injection molding of a resin composition containing, as a base, a crystalline resin such as LCP, PPS, or PEEK or an amorphous resin such as PPSU, PES, or PEI. An inner peripheral surface 7a of the housing 7 is a straight cylindrical surface having a diameter constant in an axial direction. The first bearing sleeve 8 and the second bearing sleeve 9 are fixed by the inner peripheral surface 7a while being spaced apart in the axial direction.

The first bearing sleeve 8 and the second bearing sleeve 9 are formed of a non-porous body made of metal or a porous body made of sintered metal into a cylindrical shape. In this embodiment, each of the first bearing sleeve 8 and the second bearing sleeve 9 is formed of a porous body made of sintered metal containing copper as a main component thereof into the cylindrical shape. The first bearing sleeve 8 and the second bearing sleeve 9 are fixed to the inner peripheral surface 7a of the housing 7 by appropriate means such as adhesion (including loose adhesion), press-fitting (including press-fit adhesion), or welding (including ultrasonic welding), for example. As a matter of course, the bearing sleeves 8 and 9 may be formed of a material other than metal, such as ceramic. Further, no consideration is given to whether or not the bearing sleeves 8 and 9 are porous bodies.

In an entire surface or a partial cylindrical region of an inner peripheral surface 8a of the first bearing sleeve 8, a region in which a plurality of dynamic pressure generating grooves are aligned is formed as a radial dynamic pressure generating portion. In this embodiment, as illustrated in FIG. 3(a), for example, a region in which a plurality of dynamic pressure generating grooves 8a1 are aligned in a herringbone shape is formed. Further, as illustrated in FIG. 4, also in an inner peripheral surface 9a of the second bearing sleeve 9, a region in which a plurality of dynamic pressure generating grooves 9a1 are similarly aligned in the herringbone shape is formed. The regions in which the dynamic pressure generating grooves 8a1 and 9a1 are formed serve as radial bearing surfaces, respectively, and are opposed to an outer peripheral surface 2a of the shaft member 2. During rotation of the shaft member 2, radial bearing clearances of first and second radial bearing portions R1 and R2 described later are formed between those regions and the outer peripheral surface 2a, respectively (see FIG. 2).

In an entire surface or a partial annular region of an upper end surface 8b of the first bearing sleeve 8, as a thrust dynamic pressure generating portion, as illustrated in FIG. 3(b), for example, a region in which a plurality of dynamic pressure generating grooves 8b1 are aligned in a spiral shape is formed. The region in which the dynamic pressure generating grooves 8b1 are formed serves as a thrust bearing surface, and is opposed to a lower end surface 11a of the first flange portion 11. During rotation of the shaft member 2, a thrust bearing clearance of a first thrust bearing portion T1 described later is formed between the region and the lower end surface 11a (see FIG. 2).

In an entire surface or a partial annular region of a lower end surface 9b of the second bearing sleeve 9, as illustrated in FIG. 3(c), for example, there is formed, as a thrust dynamic pressure generating portion, a region in which a plurality of dynamic pressure generating grooves 9b1 are aligned in the spiral shape. The region in which the dynamic pressure generating grooves 9b1 are formed serves as a thrust bearing surface, and is opposed to an upper end surface 12a of the second flange portion 12. During rotation of the shaft member 2, a thrust bearing clearance of a second thrust bearing portion T2 described later is formed between the region and the upper end surface 12a (see FIG. 2)

In an outer peripheral surface 8c of the first bearing sleeve 8 and an outer peripheral surface 9c of the second bearing sleeve 9 fixed to the inner peripheral surface 7a of the housing 7, one or a plurality of axial grooves 8c1 and 9c1 are formed, respectively. In this embodiment, as illustrated in FIGS. 3(b) and 3(c), the three axial grooves 8c1 and 9c1 are formed, respectively.

The spacer 10 has the cylindrical shape in this embodiment. In a state where an upper end surface 10a thereof is allowed to abut on a lower end surface 8d of the first bearing sleeve 8, and the lower end surface 10b is allowed to abut on an upper end surface 9d of the second bearing sleeve 9, the spacer 10 is disposed at substantially the center in the axial direction of the inner periphery of the housing 7.

The spacer 10 is made of a material having lower axial rigidity than those of the first and second bearing sleeves 8 and 9, and is made of, for example, a resin in this embodiment.

A dimension (outer diameter dimension) of an outer peripheral surface 10c of the spacer 10 is slightly smaller than an inner diameter dimension of the housing 7 in which the spacer 10 is to be disposed. Further, one or a plurality of axial grooves 10c1 are formed in the outer peripheral surface 10c.

Hereinafter, a description is made of a fixing step for the bearing sleeves 8 and 9 with respect to the housing 7 by taking FIGS. 4 and 5 as examples.

FIG. 4 is a view conceptually illustrating the fixing step for the first bearing sleeve 8 and the second bearing sleeve 9 with respect to the housing 7. In FIG. 4, before fixation of the first bearing sleeve 8, the second bearing sleeve 9 is positioned and fixed to the inner periphery of the housing 7 with the lower end surface 9b serving a reference surface. In this embodiment, the second bearing sleeve 9 is fixed to the housing 7 through intermediation of an adhesive. The spacer 10 is placed on the second bearing sleeve 9 in a state where the lower end surface 10b thereof is allowed to abut on the upper end surface 9d of the second bearing sleeve 9.

In this state, the first bearing sleeve 8 is introduced into the inner periphery of the housing 7 toward a position indicated by a dashed line of FIG. 4. At the same time of the introduction, the first bearing sleeve 8 is positioned in the axial direction with respect to the housing 7 with the upper end surface 8b serving as a reference surface. In this case, when a total sum of axial dimensions of the bearing sleeves 8 and 9 and the spacer 10 is equal to or less than a total sum of required axial dimensions of the members, positioning of the bearing sleeves 8 and 9 in the axial direction can be correctly performed without problem.

When the total sum of the axial dimensions of the bearing sleeves 8 and 9 and the spacer 10 exceeds the total sum of the required axial dimensions of the members, as illustrated in FIG. 5, the first bearing sleeve 8 is pushed to a predetermined position in the axial direction of the housing 7, thereby causing the spacer 10 made of a material having lower axial rigidity than those of the bearing sleeves 8 and 9 to be compressed and deformed more greatly than the bearing sleeves 8 and 9.

Accordingly, even in a case where there is large variation in deviation of axial dimensions of assembly components (the first and second bearing sleeves 8 and 9 and the spacer 10) from predetermined dimensions, the spacer 10 is compressed and deformed largely. As a result, it is possible to avoid a state where the fixing position of the first bearing sleeve 8 to be positioned after positioning and fixation of the second bearing sleeve 9 is largely shifted in the axial direction from a predetermined position, and to reliably position and fix the first and second bearing sleeves 8 and 9 with respect to the housing 7.

In particular, in this embodiment, each of the bearing sleeves 8 and 9 is formed of a porous body made of sintered metal, and the spacer 10 is formed of a resin. Accordingly, a compression deformation amount h of the spacer 10 (see FIG. 5) is substantially equal to the total sum of the variations from the predetermined dimensions of the axial dimension of the bearing sleeves 8 and 9 in a state where the first bearing sleeve 8 is positioned in the predetermined position in the axial direction (pushed to the position indicated by the dashed line of FIG. 4). Accordingly, without lowering surface accuracy of the inner peripheral surfaces 8a and 9a of the first and second bearing sleeves 8 and 9, respectively, positioning and fixation with respect to the housing 7 can be performed with high accuracy.

Further, with the above-mentioned structure, a lubricating oil existing in the radial bearing clearances described later does not escape to axial clearances between the spacer 10 and the bearing sleeves 8 and 9. Accordingly, an oil film pressure in the radial bearing clearances can be reliably increased in well balance.

Further, with the above-mentioned structure, machining for obtaining the axial dimensions of the bearing sleeves 8 and 9 with high accuracy is not necessary, so a machining cost of each of the components can be suppressed.

Further, in this embodiment, the bearing sleeves 8 and 9 are fixed to the housing 7 by adhesion, so, when the high surface accuracy (such as roundness and cylindricity) of the inner peripheral surfaces 8a and 9a is obtained, by performing the positioning and the fixation with the inner peripheral surfaces 8a and 9a serving the reference surfaces, the positioning and the fixation can be performed with high accuracy without being affected by the surface accuracy of the outer peripheral surfaces 8c and 9c. Further, machining for enhancing the surface accuracy of the outer peripheral surfaces 8c and 9c is not necessary, thereby leading to reduction in machining cost by a corresponding amount.

The shaft member 2 is made of a metal material such as stainless steel and is inserted into the inner peripheries of the first bearing sleeve 8 and the second bearing sleeve 9. The shaft member 2 has a substantially straight shaft shape as a whole. In a middle portion (a region opposed to an inner peripheral surface 10d of the spacer 10) in the axial direction of the outer peripheral surface 2a thereof, a run-off portion 2b having smaller diameter than other portions is formed. Further, of the outer peripheral surface 2a of the shaft member 2, in fixation regions for the first flange portion 11 and the second flange portion 12, annular grooves 2c as recessed portions are formed, respectively. Note that, in this embodiment, the shaft member 2 is an integral finished product made of metal, but the shaft member 2 may be a hybrid shaft (having a sheath made of metal and a core made of a resin, for example).

Each of the first flange portion 11 and the second flange portion 12 is formed of a metal material, for example, a copper alloy such as brass, or a resin material such as LCP or PPS in an annular shape. The first flange portion 11 is fixed to the outer periphery of the shaft member 2 with the lower end surface 11a thereof being opposed to the upper end surface 8b of the first bearing sleeve 8. The second flange portion 12 is fixed to the outer periphery of the shaft member 2 with the upper end surface 12a thereof being opposed to the lower end surface 9b of the second bearing sleeve 9.

The flange portions 11 and 12 are fixed to the shaft member 2. As a result, a value obtained by subtracting a total sum of the axial dimensions of the first bearing sleeve 8, the second bearing sleeve 9, and the spacer 10 which are disposed between the surfaces 11a and 12b from an axial interval between the lower end surface 11a of the first flange portion 11 and the upper end surface 12a of the second flange portion 12 opposed to each other is set to a total sum of the thrust bearing clearances of the first and second thrust bearing portions T1 and T2 described later. Accordingly, as described above, an axial width from the upper end surface 8b of the first bearing sleeve 8 to the lower end surface 9b of the second bearing sleeve 9 is accurately determined, thereby making it possible to manage the total sum of the thrust bearing clearances of the thrust bearing portions T1 and T2.

On an outer periphery of the first flange portion 11, as illustrated in FIG. 2, there is formed an annular tapered surface 11b having a diameter gradually decreasing toward an upper side in the axial direction. Similarly, also on an outer periphery of the second flange portion 12, there is formed an annular tapered surface 12b having a diameter gradually decreasing toward a lower side in the axial direction.

Therefore, in the state where the first flange portion 11 is fixed to the shaft member 2, between an outer peripheral surface including the tapered surface 11b and an upper end inner peripheral surface 7a1 of the housing 7 opposed to the outer peripheral surface, there is formed a seal space S1 of a tapered shape having a radial dimension gradually decreasing toward the lower side in the axial direction (toward the bearing inner side).

Similarly, in the state where the second flange portion 12 is fixed to the shaft member 2, between an outer peripheral surface including the tapered surface 12b and a lower end inner peripheral surface 7a2 of the housing 7 opposed to the outer peripheral surface, there is formed a seal space S2 of a tapered shape having a radial dimension gradually decreasing toward the upper side in the axial direction (toward the bearing inner side).

After the assembly is performed as described above, a lubricating oil is supplied to an inner space of the housing 7. As a result, there is achieved a fluid bearing device 1 having the bearing inner space filled with a lubricating oil, the bearing inner space including inner holes of the first bearing sleeve 8 and the second bearing sleeve 9. In this case, a total sum of volumes of the seal spaces S1 and S2 is larger than at least a volume change amount owing to a temperature change of the lubricating oil filling the inner space of the fluid bearing device 1. Accordingly, oil surfaces of the lubricating oil is continuously maintained in both the seal spaces S1 and S2.

The seal spaces S1 and S2 are formed between the outer peripheral surfaces of the flange portions 11 and 12 protruding outwardly from the shaft member 2 and the inner peripheral surface 7a of the housing 7 (upper end inner peripheral surface 7a1 and lower end inner peripheral surface 7a2), respectively. Accordingly, compared to a case where the seal space is provided between a seal portion fixed to a housing and the outer peripheral surface of the shaft member (see, for example, Patent Document 1), the seal space can be formed much closer to an outer diameter side, thereby making it possible to increase a sealing capacity. Accordingly, with a requisite capacity of the seal space being ensured, reduction in thickness of the flange portions 11 and 12 in the axial direction can be achieved, thereby achieving reduction in thickness of the fluid bearing device 1 as a whole.

In the fluid bearing device 1 constructed as described above, during rotation of the shaft member 2, a dynamic pressure generating groove 8a1-forming region of the first bearing sleeve 8 and a dynamic pressure generating groove 9a1-forming region of the second bearing sleeve 9 form the radial bearing clearances between themselves and the opposing outer peripheral surface 2a of the shaft member 2. As the shaft member 2 rotates, the above-mentioned lubricating oil in the radial bearing clearances is forced in toward the axial center of the dynamic pressure generating grooves, with the result that the pressure thereof increases. Due to this dynamic action of the lubricating oil, generated by the dynamic pressure generating grooves 8a1 and 9a1, there are respectively formed the first radial bearing portion R1 and the second radial bearing portion R2 supporting the shaft member 2 in a radial direction in a non-contact manner (see FIG. 2).

At the same time, a pressure of a lubricating oil film formed in the thrust bearing clearance between a dynamic pressure generating groove 8b1-forming region formed on the upper end surface 8b of the first bearing sleeve 8 and the lower end surface 11a of the first flange portion 11 opposed thereto, and in the thrust bearing clearance between a dynamic pressure generating groove 9b1-forming region formed on the lower end surface 9b of the second bearing sleeve 9 and the upper end surface 12a of the second flange portion 12 opposed thereto is increased by the dynamic action of the dynamic pressure generating grooves 8b1 and 9b1. By the pressure of the oil film, there are respectively formed the first thrust bearing portion T1 and the second thrust bearing portion T2 supporting the shaft member 2 in a thrust direction in a non-contact manner (see FIG. 2).

In this embodiment, as described above, the outer peripheral surface 8c of the first bearing sleeve 8, the outer peripheral surface 9c of the second bearing sleeve 9, and the outer peripheral surface 10c of the spacer 10 are provided with the axial grooves 8c1, 9c1, and 10c1, respectively, thereby forming an axial fluid flow path between themselves and the inner peripheral surface 7a of the housing 7 opposed thereto. Accordingly, during rotation of the shaft member 2, through the fluid flow path, the thrust bearing clearance of the first thrust bearing portion T1 and the thrust bearing clearance of the second thrust bearing portion T2 which are formed at an axial interval from each other communicate with each other on the outer diameter side. As a result, it is possible to avoid a state where a pressure of the fluid (lubricating oil) in one of the thrust bearing portions T1 and T2 extremely increases or decreases for some reason, thereby making it possible to stably support the shaft member 2 in the thrust direction in the non-contact manner. As a matter of course, it is also possible to achieve a structure in which the axial grooves 8c1, 9c1, and 10c1 are provided on the opposing inner peripheral surface 7a side of the housing 7, thereby forming the fluid flow path establishing communication in the axial direction between the thrust bearing gaps formed at the axial interval from each other.

According to the above description, in the fluid bearing device 1 according to this embodiment, by elongating a bearing span and managing the thrust bearing gaps with high accuracy, a run-out rigidity of the shaft member 2 can be increased. Accordingly, it is possible to reduce slide wear such as uneven contact, caused in a region other than the radial bearing surfaces and the thrust bearing surfaces. Therefore, even during high-speed rotation exceeding a rate of 10000 min⁻¹, high bearing performance can be stably exerted. Further, even in a case where wear particles are produced, the wear particles are captured by the bearing sleeves 8 and 9 each formed of a porous body, so it is possible to provide the fluid bearing device 1 which can exert high bearing performance for a long period of time.

Hereinabove, the first embodiment of the present invention is described. However, the present invention is not limited to this embodiment.

In the above embodiment, a description is made of an example in which the spacer 10 is made of a resin having a lower axial rigidity than those of the bearing sleeves 8 and 9. However, this is not obligatory. For example, the spacer 10 may be formed of an elastic body such as rubber. Further, the spacer 10 may be made of a sintered metal porous body having relatively many inner holes and easily deforming in the axial direction. Alternatively, even in a case of the spacer 10 made of the same material as that of each of the bearing sleeves 8 and 9, when the spacer 10 has an axial dimension larger than those of the bearing sleeves 8 and 9, and, as illustrated in FIG. 4, is compressed and deformed more largely in the axial direction than the bearing sleeves 8 and 9 at the time of positioning in the axial direction, the spacer 10 can be used without any problem. Further, regarding the compression deformation of the spacer 10 in the axial direction, only the compression deformation amount thereof is important, and whether the compression deformation is caused only by elastic deformation and whether the compression deformation involves plastic deformation are irrelevant thereto.

Further, in the above embodiment, the description is made of the case where, in the state where the spacer 10 is placed on the second bearing sleeve 9 fixed to the inner periphery of the housing 7, positioning and fixation of the first bearing sleeve 8 are performed. However, the process is not limited to this. For example, there may be employed a process in which, in a state where an adhesive is applied to the outer peripheral surface 10c of the spacer 10 or a region opposed thereto in advance, the positioning of the first bearing sleeve 8 is performed, and together with the first bearing sleeve 8, the spacer 10 is then adhered and fixed to the housing 7. In this case, it is possible to obtain an assembly body (fluid bearing device 1) in which the bearing sleeves 8 and 9 are adhered and fixed to the housing 7 and the spacer 10 is adhered and fixed to the inner periphery of the housing 7 while being compressed and deformed in the axial direction.

Further, in the above embodiment, the description is made of the case where the two bearing sleeves 8 and 9 and the single spacer 10 provided between the bearing sleeves 8 and 9 are arranged on the inner periphery of the housing 7. However, the present invention can also be applied to a case where three or more bearing sleeves are arranged on the inner periphery of the housing 7, and the two or more spacers 10 are arranged between the bearing sleeves.

Further, in order to increase a thrust supporting force by enlarging the thrust bearing area, for example, although not shown, the inner peripheral surface 7a of the housing 7 is formed of a small diameter portion and large diameter portions formed on both sides in the axial direction of the small diameter portion, and thrust bearing surfaces may be formed by axial end surfaces which are formed at steps between the large diameter portions and the small diameter portion, and the end surfaces 8b and 9b of the bearing sleeves 8 and 9, which are arranged in the same axial positions as the axial end surfaces, respectively. With this structure, without increasing areas of the end surfaces 8b and 9b of the bearing sleeves 8 and 9, the thrust bearing surface area can be increased. Accordingly, increase in axial load is not necessary for deforming the spacer 10 by a predetermined amount through compression.

Further, in a case where it is desired to ensure the compression deformation amount of the spacer 10 with a smaller axial load, thicknesses of the bearing sleeves 8 and 9 may be reduced to increase radial dimensions of the end surfaces at the steps of the housing 7 constituting the thrust bearing surfaces enlarged by corresponding amounts. As a matter of course, the above-mentioned structure may be provided to the side of the second thrust bearing portion T2 formed between the lower end surface 9b of the second bearing sleeve 9 and the upper end surface 12a of the second flange portion 12 opposed thereto.

Further, in the above embodiment, there are exemplified a structure in which the two flange portions 11 and 12 are fixed to the shaft member 2, and opening portions at the opposite ends of the housing 7 are sealed thereby. However, the present invention may also be applied to a fluid bearing device which includes a housing having closed one end and in which another end is opening portion sealed between the outer peripheral surface of the one flange portion fixed to the shaft member and the surface opposed thereto. Alternatively, although not shown as well, the present invention may also be applied to a fluid bearing device having a structure in which the one flange portion fixed to the shaft member 2 is disposed on a bottom side of the bottomed cylindrical housing and the thrust bearing clearances are formed between both end surfaces of the flange portion and the surfaces opposed thereto (such as the lower end surface 9b of the second bearing sleeve 9). Further, the flange portion does not necessarily form the seal space by the outer periphery thereof, and the present invention may also be applied to a structure in which a seal portion is provided to a member on the bearing side (side of the housing 7 or the bearing sleeves 8 and 9 fixed to the housing 7) separately from, for example, the flange portion and the seal space is formed between the inner peripheral surface of the seal portion and the outer peripheral surface 2a of the shaft member 2 opposed thereto.

FIG. 6 illustrates a fluid bearing device according to a second embodiment of the present invention. On an inner periphery of a bottomed cylindrical housing 27, the first and second bearing sleeves 8 and 9 and the spacer 10 are arranged, and between the lower end surface 9b of the second bearing sleeve 9 and an upper end surface 7b1 of a bottom portion 7b of the housing 7, a flange portion 22b provided to one end of a shaft member 22 is accommodated. In this illustrated example, a step 27d is formed between a cylinder portion 27a and the bottom portion 27b of the housing 27. The lower end surface 9b of the second bearing sleeve 9 is allowed to abut on an axial end surface 27d1 of the step 27d, thereby positioning the bearing sleeve 9 with respect to the housing 27. An annular seal member 30 is fixed to an inner periphery of an upper end portion of the cylinder portion 27a of the housing 27, in a state where a lower end surface 30a is allowed to abut on the upper end surface 8b of the first bearing sleeve 8. A seal space S3 is formed between an inner peripheral surface 30b of the seal member 30 and an outer peripheral surface 22a1 of the shaft member 22 opposed thereto. Further, in this embodiment, the dynamic pressure generating grooves illustrated in FIG. 3(b) are formed in the upper end surface 27b1 of the bottom portion 27b of the housing 27 instead of in the upper end surface 8b of the first bearing sleeve 8. Other constructions are the same as those of the above first embodiment, so descriptions thereof are omitted.

With the above-mentioned structure, during relative rotation of the shaft member 22, by the dynamic pressure generating grooves 8a1 and 9a1 provided to the inner peripheral surfaces 8a and 9a of the bearing sleeves 8 and 9, respectively, the dynamic action of the lubricating oil is generated between the radial bearing clearances between the dynamic pressure generating groove 8a1, 9a1-forming regions and the outer peripheral surface 22a1 of a shaft portion 22a. By the pressure of the oil film increased by the dynamic action, there are formed a first radial bearing portion R11 and a second radial bearing portion R12 supporting the shaft member 22 rotatably in a radial direction in a non-contact manner (see FIG. 6).

At the same time, in the thrust bearing clearance between the dynamic pressure generating groove 9b1-forming region formed on the lower end surface 9b of the second bearing sleeve 8 and the lower end surface 11a of the flange portion 22b opposed thereto, and in the thrust bearing clearance between a dynamic pressure generating groove-forming region formed on the upper end surface 27b12 of the housing bottom portion 27b and a lower end surface 22b2 of the flange portion 22b opposed thereto, there is generated the dynamic action of the lubricating oil. By the pressure of the oil film increased by the dynamic action, there are formed a first thrust bearing portion T11 and a second thrust bearing portion T12 supporting the shaft member 22 in the thrust direction in an on-contact manner.

Also in this embodiment, as illustrated in FIG. 5, for example, the first bearing sleeve 8 is pushed to a predetermined position in the axial direction with respect to the housing 27. Further, the spacer 10 made of a material having a lower axial rigidity than those of the bearing sleeves 8 and 9 is compressed and deformed more greatly than the bearing sleeves 8 and 9. As a result, it is possible to reliably position and fix the first and second bearing sleeves 8 and 9 with respect to the housing 27. At the same time, an axial width from the upper end surface 8b of the first bearing sleeve 8 to the lower end surface 9b of the second bearing sleeve 9 is accurately defined.

In this embodiment, each of the bearing sleeves 8 and 9 are axially positioned with respect to the housing 27 with high accuracy. As a result, the inner peripheral surfaces 8a and 9a can be accurately opposed to, of the outer peripheral surface 22a1 of the shaft member 22 opposed thereto, while avoiding a small diameter surface 22a2 constituting a run-off portion, a large diameter surface 22a3 which constitutes the radial bearing surface, without axial deviation. Thus, radial rigidity can be further increased.

Further, in the above embodiments, the description is made of the case where the dynamic pressure generating portions such as the dynamic pressure generating grooves are formed on the inner peripheral surface 8a and the upper end surface 8b of the first bearing sleeve 8, the inner peripheral surface 9a and the lower end surface 9b of the second bearing sleeve 9, or the upper end surface 27b1 of the bottom portion 27b of the housing 27. However, this is not obligatory. For example, the dynamic pressure generating portions may also be formed on the outer peripheral surface 2a of the shaft member 2 opposed to the above-mentioned surfaces, the lower end surface 11a of the first flange portion 11, or the upper end surface 12a of the second flange portion 12. Further, there may be employed a configuration in which the hub 3 is formed integrally with or separately from the shaft member 2, and the dynamic pressure generating portion is formed on one of the lower end surface of the hub 3, and the housing 7 opposed thereto and the upper end surface 8b of the first bearing sleeve 8. The dynamic pressure generating portions according to a mode described below may be similarly formed on the side of the opposing shaft member 2.

Further, while in the above embodiments, there is given the example in which the radial bearing portions R1 and R2 and the thrust bearing portions T1 and T2 generate the dynamic action of the lubricating fluid by the dynamic pressure generating grooves in the herringbone shape and the spiral shape, the present invention is not limited to this construction. The radial bearing portions R11 and R12 and the thrust bearing portions T11 and T12 illustrated in FIG. 6 are also formed in the same manner.

For example, although not shown, as the radial bearing portions R1 and R2, it is also possible to adopt a so-called step-like dynamic pressure generating portion, in which a plurality of axial grooves are formed circumferentially, or a so-called multi-arc bearing, in which a plurality of arcuate surfaces are arranged circumferentially, forming wedge-like radial clearances (bearing clearances) between themselves and the opposing outer peripheral surface 2a of the shaft member 2.

Alternatively, it is also possible to form at least one of the inner peripheral surface 8a of the first bearing sleeve 8 or the inner peripheral surface 9a of the second bearing sleeve 9 as a cylindrical inner peripheral surface provided with no dynamic pressure generating groove, arcuate surface, etc. as the dynamic pressure generating portion, forming a so-called cylindrical bearing (fluid lubrication bearing) between this inner peripheral surface and the cylindrical outer peripheral surface 2a of the shaft member 2 opposed thereto.

Further, although not shown as well, one or both of the thrust bearing portions T1 and T2 may be formed by a so-called step bearing, a so-called wave-type bearing (with an undulated step pattern), or the like, in which a plurality of dynamic pressure generating grooves in the form of radial grooves are provided at predetermined circumferential intervals in the region constituting the thrust bearing surface.

Further, other than a structure in which the shaft member 2 is supported in a non-contact manner by the dynamic action of the dynamic pressure generating grooves, the thrust bearing portions T1 and T2 may have a structure of a so-called pivot bearing in which the end portion of the shaft member 2 is formed in a spherical surface shape and the shaft member 2 is supported between the end portion and the thrust bearing surface in a contact manner.

Further, in the above first and second embodiments, as a fluid filling an inside of the fluid bearing device 1, 21 and forming the lubricating film in the radial bearing clearance and the thrust bearing clearance, the lubricating oil is given as an example. However, other than that, there may be used a fluid which may generate the dynamic action in the bearing clearances, for example, a gas such as air, a lubricant having fluidity such as a magnetic fluid, a lubricating grease, or the like.

FIG. 7 is a diagram conceptually illustrating a construction example of an information apparatus spindle motor into which a fluid bearing device (fluid dynamic pressure bearing device) 31 according to a third embodiment of the present invention is incorporated. The spindle motor is used in a disk drive, such as an HDD, and is equipped with: the fluid bearing device 31 for rotatably supporting a shaft member 32 in a non-contact manner; a rotor (disk hub) 33 mounted to the shaft member 32; and a stator coil 34 and a rotor magnet 35 opposed to each other through the intermediation of, for example, a radial gap. The stator coil 34 is mounted to an outer periphery of a bracket 36, and the rotor magnet 35 is mounted to an inner periphery of the disk hub 33. A housing 37 of the fluid bearing device 31 is mounted to the inner periphery of the bracket 36. One or a plurality of disks D such as magnetic disks are retained by the disk hub 33. When electricity is supplied to the stator coil 34, the rotor magnet 35 is rotated by an electromagnetic force generated between the stator coil 34 and the rotor magnet 35, and with this rotation, the disk hub 33 is rotated integrally with the shaft member 32.

FIG. 8 illustrates the fluid bearing device 31 according to the third embodiment of the present invention. The fluid bearing device 31 includes, as main components thereof, the shaft member 32 serving as a rotating side, the housing 37 serving as a stationary side, and a bearing main body 38 fixed to an inner periphery of the housing 37. In this embodiment, the shaft member 32 includes a shaft portion 32a, a first flange portion 39 and a second flange portion 40 which are fixed to the shaft portion 32a. Further, the bearing main body 38 includes a plurality of bearing sleeves arranged in the axial direction. In this embodiment, the bearing main body 38 includes a first bearing sleeve 81 and a second bearing sleeve 82 provided at a predetermined axial interval. Note that, for the convenience of description, a description is made while setting a side on which an end portion of the shaft member 32 (shaft portion 32a) protrudes from an opening portion of the housing 37 to an upper side and a side axially opposite thereto to a lower side.

The shaft member 32 includes the shaft portion 32a formed of a metal material such as stainless steel, and the first and second flange portions 39 and 40 formed separately from the shaft portion 32a and protruding outwardly. The shaft portion 32a has a straight shaft shape as a whole.

Each of the first flange portion 39 and the second flange portion 40 is formed of a soft metal material such as brass, other metal materials, or a resin material in a ring shape, and is adhered and fixed to, for example, an outer peripheral surface 32a1 of the shaft portion 32a. In this embodiment, of the outer peripheral surface 32a1 of the shaft portion 32a, in positions to which the first and second flange portions 39 and 40 are fixed, recessed circumferential grooves 32a2 are formed. At the time of adhesive fixation, an adhesive applied to the shaft portion 32a is charged into the circumferential grooves 32a2 serving as adhesive reservoirs and is solidified, thereby improving adhesion strength of the flange portions 39 and 40 with respect to the shaft portion 32a.

An outer peripheral surface 39a of the first flange portion 39 fixed to the shaft portion 32a forms the first seal space S1 of a predetermined volume between itself and an inner peripheral surface 37a on an upper opening portion side of the housing 37. Further, an outer peripheral surface 40a of the second flange portion 40 forms the second seal space S2 of a predetermined volume between itself and the inner peripheral surface 37a on a lower opening portion side of the housing 37. In this embodiment, each of the outer peripheral surface 39a of the first flange portion 39 and the outer peripheral surface 40a of the second flange portion 40 is formed in a tapered surface having a diameter gradually decreasing toward an outer side of the bearing device. Accordingly, both the seal spaces S1 and S2 form tapered shapes having diameters gradually decreasing toward a direction of approaching each other (toward an inside of the housing 37). During rotation of the shaft member 32, the lubricating oil in both the seal spaces S1 and S2 is led in a direction in which the seal spaces narrow by a pull-in effect owing to a capillary force and a pull-in effect owing to a centrifugal force during the rotation. As a result, leakage of the lubricating oil from the inside of the housing 37 can be effectively prevented. In order to reliably prevent the oil leakage, on each of an upper and lower end surfaces of the housing 37, an upper end surface 39c of the first flange portion 39, and a lower end surface 40c of the second flange portion 40, there may be formed a covering film formed of oil repellent agent (not shown).

The first and second seal spaces S1 and S2 have a buffer function of absorbing a volume change amount, due to a temperature change of a lubricating oil filling an inner space of the housing 37. Within a range of an estimated temperature change, the oil surface is always within both the seal spaces S1 and S2. In order to realize this, a total sum of the volume of both the seal spaces S1 and S2 are set so as to be larger than the volume change amount, owing to the temperature change, of the lubricating oil charged to fill the inner space.

The housing 37 is formed of a soft metal such as an aluminum alloy or brass in a substantially cylindrical shape. The inner peripheral surface 37a of the housing 37 is formed in a smooth straight cylindrical surface in an axial entire length thereof. The housing 37 is fixed to the inner peripheral surface of the bracket 36 illustrated in FIG. 1 by means of press-fitting, adhesion, press-fitting adhesion, welding, or the like.

The housing 37 can be made, for example, by using a resin in addition to a metal material. In this case, the housing 37 may be formed by injection molding using a resin composition whose base component is a crystalline resin, such as liquid crystal polymer (LCP), polyphenylene sulfide (PPS), or polyetheretherketone (PEEK), or an amorphous resin, such as polysulfone (PSU), polyethersulfone (PES), or polyphenylsulfone (PPSU). One, two, or more types of fillers of various types such as a reinforcement material, a conductive material, and a lubricant are mixed with the base resin depending on prescribed characteristics.

The bearing sleeves 81 and 82 constituting the bearing main body 38 are formed of a porous body made of sintered metal, a porous body particularly made of sintered metal containing copper as a main component thereof, or soft metal such as brass in a cylindrical shape, and are adhered and fixed to predetermined positions on the housing 37. In a state where the first bearing sleeve 81 and the second bearing sleeve 82 are adhered and fixed to the predetermined positions on the housing 37, a space portion 110 having an axial width t1 is formed between the first bearing sleeve 81 and the second bearing sleeve 82. In this embodiment, both the bearing sleeves 81 and 82 are formed in the same axial length.

The adhesive fixation between the first bearing sleeve 81 and the housing 37 is performed by charging and solidifying an adhesive in a first adhesion clearance 120 provided between an outer peripheral surface 81d of the first bearing sleeve 81 and the inner peripheral surface 37a of the housing 37. Further, the adhesive fixation between the second bearing sleeve 82 and the housing 37 is performed by charging and solidifying an adhesive in a second adhesion clearance 130 provided between a outer peripheral surface 82d of the second bearing sleeve 82 and the inner peripheral surface 37a of the housing 37. A width (radial width) t2 of the first adhesion clearance 120 in which the adhesive is charged is set smaller than the axial width t1 of the space portion 110 (t1>t2). Further, a width (radial width) t3 of the second adhesion clearance 130 is also set smaller than the axial width t1 of the space portion 110 (t1>t3).

Of the bearing main body 38, the inner peripheral surface 81a of the first bearing sleeve 81 disposed on an axially upper side is provided with a region constituting a radial bearing surface A of the first radial bearing portion R1. In the region constituting the radial bearing surface A, as the dynamic pressure generation portion, there are formed as illustrated in FIG. 9(b), for example, dynamic pressure generating grooves 81a1 formed in the herringbone shape and a hill portion 81a2 partitioning the dynamic pressure generating grooves 81a1. The radial bearing surface A of the first bearing sleeve 81 is formed at an end portion on a side (upper side) away from the second bearing sleeve 82. Further, of the bearing main body 8, the inner peripheral surface 82a of the second bearing sleeve 82 positioned on a lower side is provided with a region constituting a radial bearing surface A of the second radial bearing portion R2. In the region constituting the radial bearing surface A, as the dynamic pressure generation portion, there are formed, as illustrated in FIG. 9(b), for example, dynamic pressure generating grooves 82a1 in the herringbone shape and a hill portion 82a2 partitioning the dynamic pressure generating grooves 82a1. The radial bearing surface A of the second bearing sleeve 82 is formed at an end portion on a side (lower side) away from the first bearing sleeve 81.

Of the radial bearing surfaces formed on the two bearing sleeves 81 and 82, the dynamic pressure generating grooves 81a1 formed in the radial bearing surface A of the first bearing sleeve 81 are formed so as to be axially asymmetrical with respect to an axial center m (axial center of a region provided between upper and lower inclined gaps). An axial dimension X1 of an upper region with respect to the axial center m is larger than an axial dimension X2 of a lower region with respect thereto. Accordingly, during rotation of the shaft member 32, a pull-in force (pumping force) of the lubricating oil by the dynamic pressure generating grooves 81a1 is larger in a downward direction than an upward direction. On the other hand, the dynamic pressure generating grooves 82a1 formed in the radial bearing surface A of the second bearing sleeve 82 are formed so as to be symmetrical in the axial direction, and there is no difference between the downward and upward pumping forces. Accordingly, in a clearance between the inner peripheral surfaces 81a and 82a of the bearing sleeves 81 and 82 and the outer peripheral surface 32a1 of the shaft member 32, the lubricating oil flows downwardly. Note that, regarding the shape of the dynamic pressure generating grooves 81a1 and 82a1, other known shapes, for example, the spiral shape or the like may be adopted.

In a partial or entire annular region of an upper end surface 81b of the first bearing sleeve 81, a thrust bearing surface of the first thrust bearing portion T1 is formed. In the thrust bearing surface, as illustrated in FIG. 9(a), for example, dynamic pressure generating grooves 81b1 in the spiral shape are formed. Further, in a partial or entire annular region of a lower end surface 82c of the second bearing sleeve 82, a thrust bearing surface of the second bearing portion T2 is formed. In the thrust bearing surface, as illustrated in FIG. 9(c), for example, dynamic pressure generating grooves 82c1 in the spiral shape are formed. One or both groups of the dynamic pressure generating grooves formed in the thrust bearing surfaces may be formed in other known shape, for example, the herringbone shape.

Assembly of the fluid bearing device 1 having the above-mentioned structure is performed, for example, as described below.

In a state where a region of the inner peripheral surface 37a of the housing 37, facing the second adhesion clearance 130, or the outer peripheral surface 82d of the second bearing sleeve 82 is applied with an adhesive, the second bearing sleeve 82 having the inner periphery in which an assembling pin is press-fitted is moved to and positioned at a predetermined position of the inner periphery of the housing 37, and the adhesive is solidified. The adhesive may be charged into the second adhesion clearance 130 after the second bearing sleeve 82 is moved to the predetermined position. Next, the first bearing sleeve 81 is press-fitted to and positioned at a predetermined position of an outer periphery of the assembling pin, and the adhesive is solidified. Note that, similarly to the case of adhering and fixing the second bearing sleeve 82, the adhesive for fixing the first bearing sleeve 81 is charged in the first adhesion clearance 120 between the first bearing sleeve 81 and the housing 37 after the positioning, but may be applied in advance to the region of the inner peripheral surface 37a of the housing 37, opposed to the first adhesion clearance 120 or to the outer peripheral surface 81d of the first bearing sleeve 81 instead.

Of assemblies assembled as described above, after the shaft portion 32a is inserted into the inner periphery of the bearing main body 38, the first flange portion 39 and the second flange portion 40 are adhered and fixed to predetermined positions of the shaft portion 32a so as to sandwich the bearing main body 38. When assembling of the fluid bearing device 31 is completed, as the lubricating fluid, for example, the lubricating oil is charged to fill the inner space of the housing 37, which is hermetically sealed by both the flange portions 39 and 40, including inner holes of both the bearing sleeves 81 and 82.

In the fluid bearing device 31 of the above-mentioned structure, when the shaft member 32 rotates, each of the radial bearing surface A of the inner peripheral surface 81a of the first bearing sleeve 81 and the radial bearing surface A of the second bearing sleeve 82 is opposed to the outer peripheral surface 32a1 of the shaft portion 32a through the intermediation of the radial bearing clearance. Along with the rotation of the shaft member 32, the lubricating oil film formed in the radial bearing clearances are increased in oil film strength owing to the dynamic action of the dynamic pressure generating grooves 81a1 and 82a1 formed in both the radial bearing surfaces, respectively. Accordingly, the shaft member 32 is supported rotatably in the radial direction in a non-contact manner. As a result, the first radial bearing portion R1 and the second radial bearing portion R2 supporting the shaft member 32 rotatably in the radial direction in a non-contact manner are formed at an axial interval therebetween.

Further, when the shaft member 32 rotates, the region of the upper end surface 81b of the first bearing sleeve 81, constituting the thrust bearing surface is opposed to the lower end surface 39b of the first flange portion 39 through the intermediation of the predetermined thrust bearing clearance, and the region of the lower end surface 82c of the second bearing sleeve 82, constituting the thrust bearing surface is opposed to the upper end surface 40b of the second flange portion 40 through the intermediation of the predetermined thrust bearing clearance. When the shaft member 32 rotates, the lubricating oil film formed in each of the thrust bearing clearances is increased in oil film strength by the dynamic action of the dynamic pressure generating grooves 81b1 and 82c1 formed in the thrust bearing surfaces, respectively, and the shaft member 32 is supported rotatably in both the thrust directions in a non-contact manner. As a result, there are formed the first thrust bearing portion T1 and the second thrust bearing portion T2 supporting the shaft member 32 rotatably in both the thrust directions in a non-contact manner.

Like in the above-mentioned structure, when, between the two bearing sleeves 81 and 82 adjacent to each other in the axial direction, there is provided the space portion 110 having a width larger than that of each of the adhesion clearances 120 and 130 formed between the adjacent bearing sleeves 81 and 82 and the housing 37, a capillary force is not generated in the space portion 110, or the capillary force generated in the space portion is smaller than a capillary force generated in the adhesion clearances 120 and 130. Accordingly, a phenomenon is prevented, in which an adhesive charged in the adhesion clearances 120 and at the time of adhesive fixation is led into the space portion provided between the bearing sleeves 81 and 82, by extension, the adhesive enters an inner diameter side of the bearing sleeve. Note that, depending on an assembling method or process, the adhesive runs into the space portion 110 (bearing sleeve end surface side). However, the width of each of the adhesion clearances 120 and 130 is set smaller than the width of the space portion 110, so the adhesive running to the space portion 110 side is returned to the side of the adhesion clearances 120 and 130 by the capillary force generated in the adhesion clearances 120 and 130. Even if the adhesive running into the space portion 110 is not returned to the side of the adhesion clearances 120 and 130, the width t1 of the space portion 110 is set to become large. Accordingly, the adhesive is stored in a range of the space portion 110, thereby making it possible to prevent the adhesive from entering the inner diameter side of the sleeve. By a synergistic effect as described above, it is possible to reliably prevent the adhesive from entering the inner diameter side of the sleeve, thereby making it possible to provide the fluid bearing device, which can exhibit desired bearing performance.

Note that, in the structure of this embodiment, compared to the conventional structure in which the thrust bearing portion as illustrated in FIG. 13(a) is formed by a pivot bearing, the thrust bearing portions can be provided in two positions in the axial direction and the interval distance therebetween can be large, so the moment rigidity in the thrust bearing portions can be increased.

In the above-mentioned description, there is exemplified a mode in which the radial bearing surface A of the first bearing sleeve 81 is formed on the end portion on the opposite side (upper side) of the second bearing sleeve 82, and the radial bearing surface A of the second bearing sleeve 82 is formed on the end portion on the opposite side (lower side) of the first bearing sleeve. In this mode, the bearing sleeve has an upper region and a lower region having inner diameter dimensions different from each other, so there may be a case where it is difficult to ensure coaxiality between the upper and lower end surfaces of each of the bearing sleeves and between both the bearing sleeves. In this case, as illustrated in FIG. 10, for example, convex portions 81a3 and 82a3 having substantially the same diameter as that of the radial bearing surfaces A (hill portions 81a2 and 82a2 partitioning the dynamic pressure generating grooves) are provided in regions each positioned at an axial interval from each of the radial bearing surfaces A, thereby making it possible to solve the above-mentioned problem.

However, when each of the above-mentioned convex portions 81a3 and 82a3 assumes a shape having a dynamic pressure generating function like the dynamic pressure generating grooves formed in the radial bearing surfaces A, there is a risk of resulting in increase in torque. Accordingly, the convex portions 81a3 and 82a3 are desirably formed in a belt-like shape or the like having no dynamic pressure generating function as shown in the illustrated example. Note that, in the illustrated example, the convex portions are formed in both the bearing sleeves 81 and 82. However, the convex portions may be provided to only one of the bearing sleeves.

Further, in a case where the axial lengths of the first and second bearing sleeves 81 and 82 are made identical to each other like in the above-mentioned structure, a difference in appearance therebetween is small, so, at the time of assembly, there is a risk of assembling the sleeves with the vertical positions of the sleeves being erroneously switched with each other by an operator. In this case, although not shown, in order to prevent a technical mistake, the axial lengths of the first bearing sleeve 81 and the second bearing sleeve 82 may be made different from each other.

FIG. 11 illustrates a fluid bearing device 41 according to a fourth embodiment of the present invention. The fluid bearing device 41 of this embodiment differs from that of the third embodiment of the present invention illustrated in FIG. 8, in that the bearing main body 38 is formed of the first and second bearing sleeves 81 and 82 and the spacer member 83 of a ring shape interposed between the first and second bearing sleeves 81 and 82. The spacer member 83 is made of a soft metal material such as brass, other metal materials, a resin material, or a sintered metal material in a ring shape having a larger inner diameter dimension than those of both the bearing sleeves 81 and 82.

In this embodiment, between the first bearing sleeve 81 and the spacer member 83 and between the spacer member 83 and the second bearing sleeve 82, space portions 140 and 160 are provided, respectively. An axial width t4 of the space portion 140 on the upper side is set larger than the radial width t2 of the first adhesion clearance 120 provided between the first bearing sleeve 81 and the housing 37 and a radial width t5 of a third adhesion clearance 150 provided between the spacer member 83 and the housing 37 (t4>t2 and t4>t5). Further, an axial width t6 of the space portion 160 on the lower side is set larger than the radial width t5 of the third adhesion clearance 150 provided between the spacer member 83 and the housing 37 and the radial width t3 of the second adhesion clearance 130 provided between the second bearing sleeve 82 and the housing 37 (t6>t5 and t6>t3). With this structure, the same effects as those of the embodiment illustrated in FIG. 8 are obtained.

In the above embodiments, the description is made of the case where each of the dynamic pressure generating portions such as the dynamic pressure generating grooves are formed on the inner peripheral surface 81a or the upper end surface 81b of the first bearing sleeve 81, or the inner peripheral surface 82a or the lower end surface 82c of the second bearing sleeve 82. However, this is not obligatory. For example, each of the dynamic pressure generating portions may also be formed on the outer peripheral surface 32a of the shaft member 32 opposed to the above-mentioned surfaces, the lower end surface 39b of the first flange portion 39, or the upper end surface 40b of the second flange portion 40. Further, there may be employed a configuration in which the hub 33 is formed integrally with or separately from the shaft member 32, and the dynamic pressure generating portion is formed on one of the lower end surface of the hub 33, and the housing 37 opposed thereto and the upper end surface 81b of the first bearing sleeve 81.

Further, while there is given the example in which the radial bearing portions R1 and R2 and the thrust bearing portions T1 and T2 generate the dynamic action of the lubricating fluid by the dynamic pressure generating grooves arranged in the herringbone shape and the spiral shape, the present invention is not limited to this construction.

For example, although not shown, as the radial bearing portions R1 and R2, it is also possible to adopt a so-called step-like dynamic pressure generating portion, in which a plurality of axial grooves are formed circumferentially, or a so-called multi-arc bearing, in which a plurality of arcuate surfaces are arranged circumferentially, forming wedge-like radial clearances (bearing clearances) between themselves and the opposing outer peripheral surface 32a of the shaft member 32.

Alternatively, it is also possible to form at least one of the inner peripheral surface 81a of the first bearing sleeve 81 or the inner peripheral surface 82a of the second bearing sleeve 82 as a cylindrical inner peripheral surface provided with no dynamic pressure generating groove, arcuate surface, etc. as the dynamic pressure generating portion, forming a so-called cylindrical bearing (fluid lubrication bearing) between this inner peripheral surface and the cylindrical outer peripheral surface 32a of the shaft member 32 opposed thereto.

Further, although not shown as well, one or both of the thrust bearing portions T1, T2 may be formed by a so-called step bearing, a so-called wave-type bearing (with an undulated step pattern), or the like, in which a plurality of dynamic pressure generating grooves in the shape of radial grooves are provided at predetermined circumferential intervals in the region constituting the thrust bearing surface.

Further, other than being formed by supporting the shaft member 32 in a non-contact manner by the dynamic action of the dynamic pressure generating grooves, the thrust bearing portions T1 and T2 may be formed by a so-called pivot bearing in which the end portion of the shaft member 32 is formed in a spherical surface shape and the shaft member 32 is supported between the end portion and the thrust bearing surface opposed thereto in a contact manner.

Further, in the above-mentioned description, the description is made of a mode in which the bearing main body 8 is formed of the bearing sleeves 81 and 82 arranged at two positions in the axial direction. However, the bearing main body 8 may be formed by arranging the bearing sleeves at three or more positions in the axial direction.

Further, as a fluid filling an inside of the fluid bearing device 31, 41 and forming the lubricating film in the radial bearing clearance and the thrust bearing clearance, the lubricating oil is given as an example. However, other than that, there may be used a fluid which may generate the dynamic action in the bearing clearances, for example, a gas such as air, a lubricant having fluidity such as a magnetic fluid, a lubricating grease, or the like.

Hereinabove, there is an example of a mode in which the fluid bearing device is used while being incorporated into a spindle motor for a disk device. However, the fluid bearing device of the present invention can be preferably used for, other than the spindle motor for information equipment, a motor which rotates at high speed and of which high moment rigidity is demanded, for example, a fan motor.

FIG. 12 conceptually illustrates an example of a fan motor in which, for example, the fluid bearing device 31 according to the third embodiment of the present invention is incorporated, specifically, a so-called radial gap type fan motor having a structure in which a stator coil 44 and a rotor magnet 45 are opposed to each other through the intermediation of a gap in the radial direction. The motor of the illustrated example is different in structure from the structure of the spindle motor illustrated in FIG. 7, in that a rotor 43 fixed to an outer periphery of an upper end of the shaft member 32 has a fin on an outer periphery thereof and in that a bracket 46 functions as a casing for accommodating components of the motor. Note that other components are the same in function and effect as those of the components of the motor illustrated in FIG. 7, so a redundant description of those is omitted.

### BRIEF DESCRIPTION OF THE DRAWINGS

FIG. 1 is a sectional view of a spindle motor in which a fluid bearing device according to a first embodiment of the present invention is incorporated.

FIG. 2 is a sectional view of the fluid bearing device according to the first embodiment of the present invention.

FIG. 3 (a) is a sectional view of a first bearing sleeve, FIG. 3(b) is an upper end view of the first bearing sleeve viewed from a direction of an arrow a, and FIG. 3(c) is a lower end view of a second bearing sleeve viewed from a direction of an arrow b.

FIG. 4 is a view conceptually illustrating a step of fixing a bearing sleeve to a housing.

FIG. 5 is a partially enlarged view conceptually illustrating the step of fixing the bearing sleeve to the housing.

FIG. 6 is a sectional view illustrating a fluid bearing device according to a second embodiment of the present invention.

FIG. 7 is a sectional view illustrating a spindle motor in which a fluid bearing device according to a third embodiment of the present invention is incorporated.

FIG. 8 is a sectional view of the fluid bearing device according to the third embodiment of the present invention.

FIG. 9(a) is a view illustrating an upper end surface of a first bearing sleeve, FIG. 9(b) is a longitudinal sectional view of a bearing sleeve, and FIG. 9(c) is a view illustrating a lower end surface of a second bearing sleeve.

FIG. 10 is a longitudinal sectional view illustrating a bearing sleeve according to another mode of the present invention.

FIG. 11 is a sectional view illustrating a fluid bearing device according to a fourth embodiment of the present invention.

FIG. 12 is a sectional view of a fan motor in which the fluid bearing device is incorporated.

FIG. 13(a) is a schematic view illustrating an example of a fluid bearing device having a conventional structure and FIG. 13(b) is a schematic view illustrating another example of the fluid bearing device having the conventional structure.

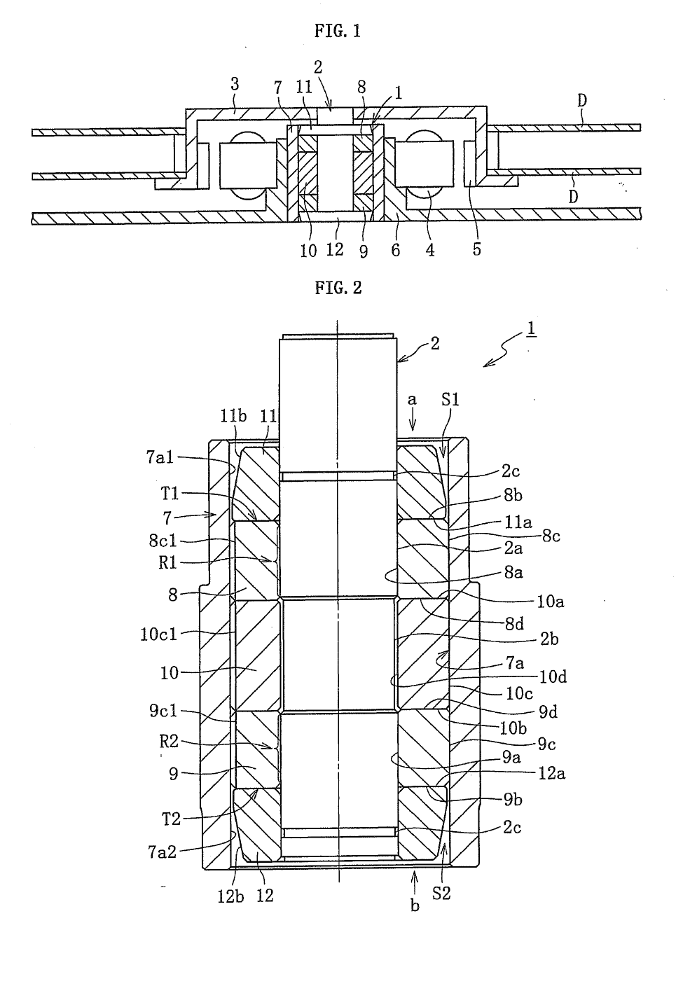

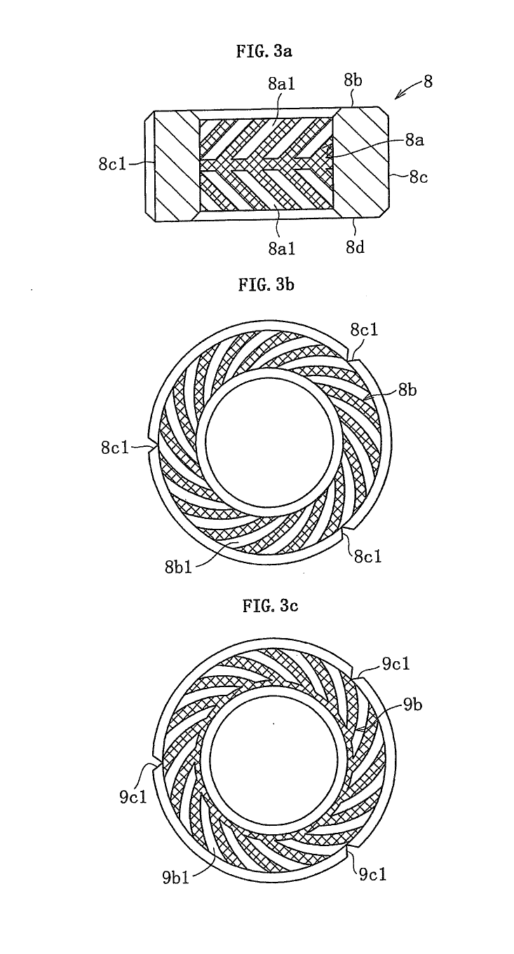

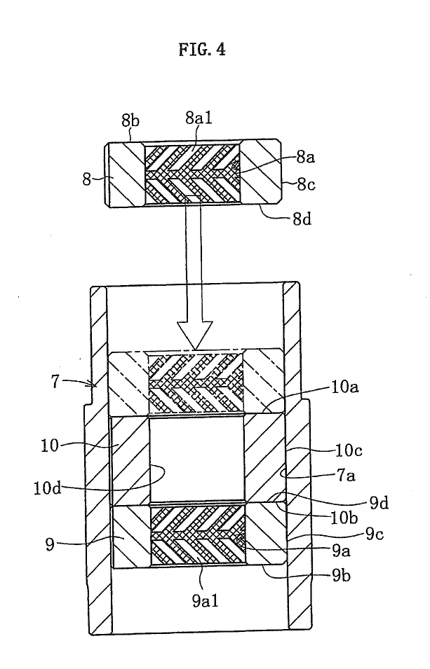

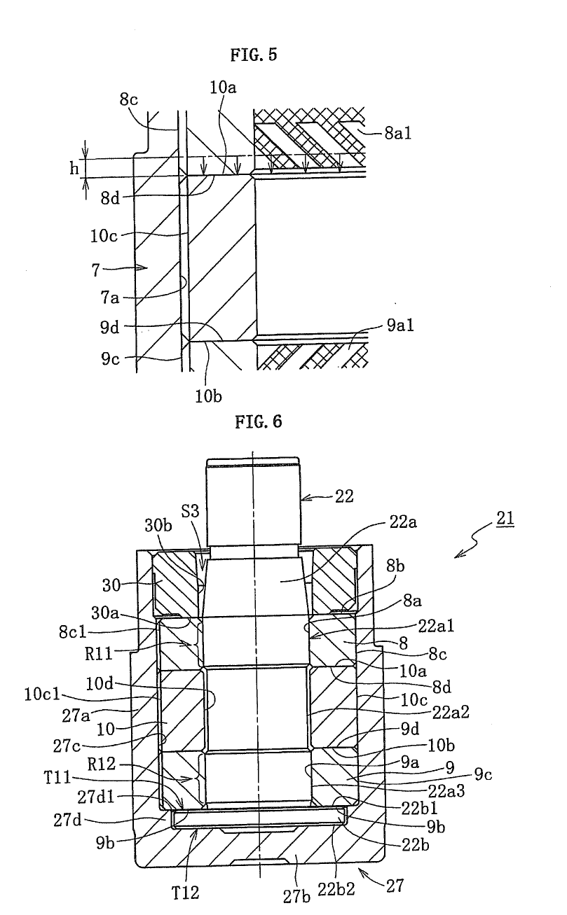

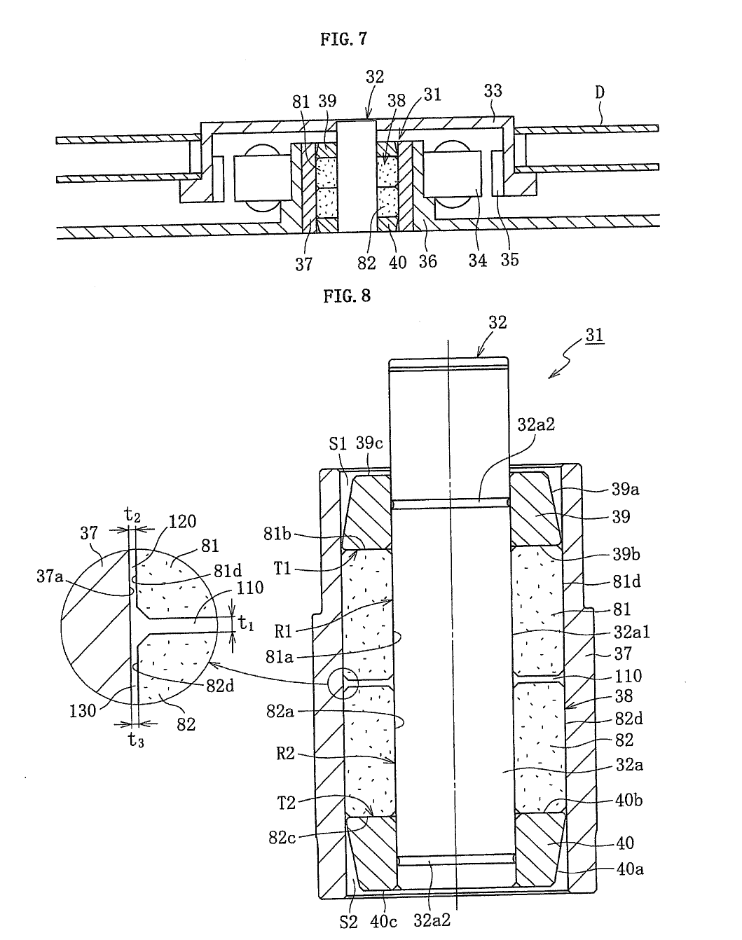

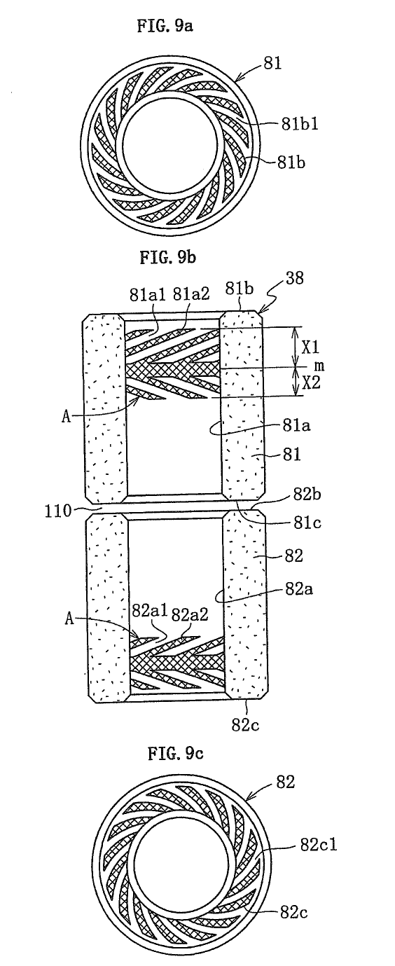

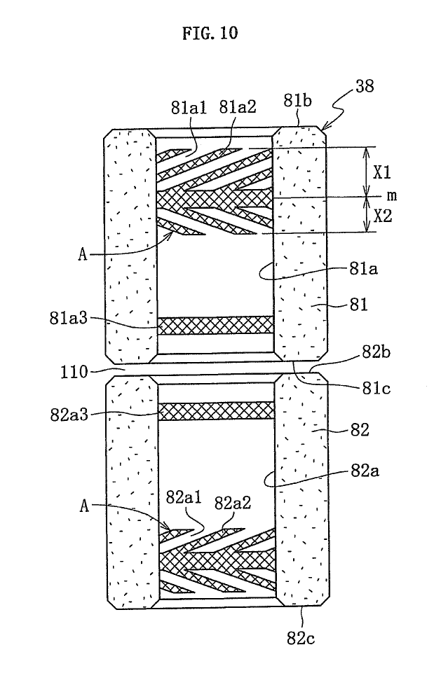

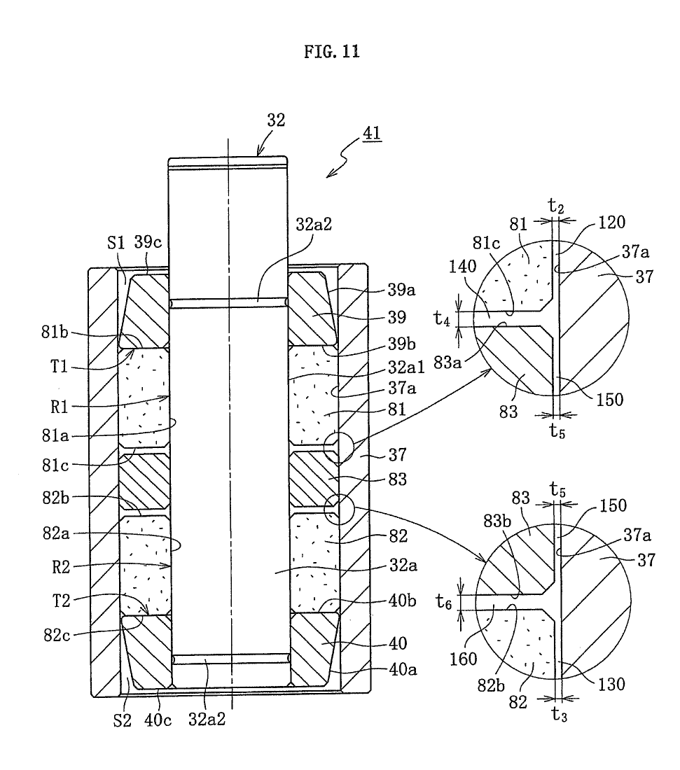

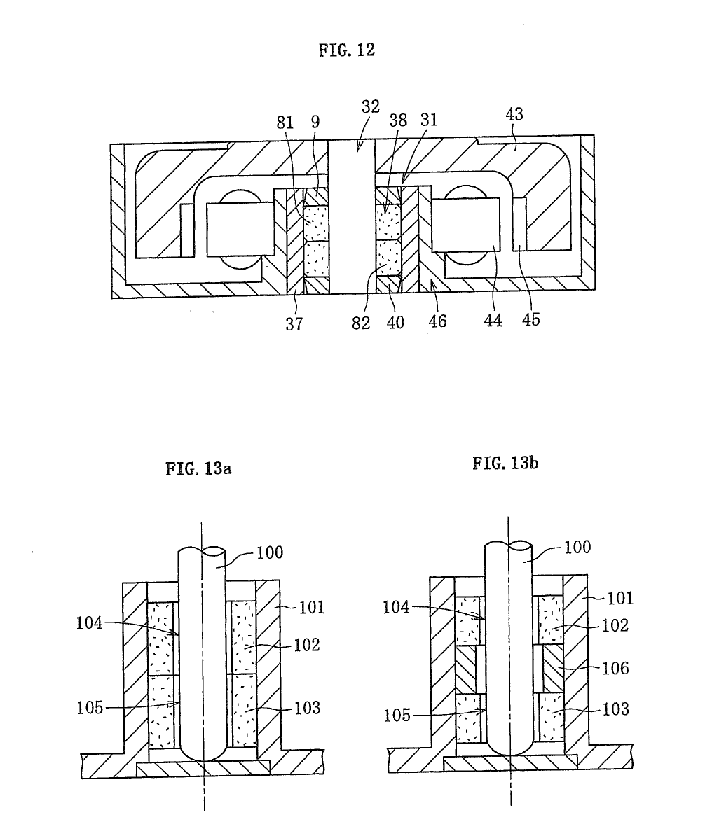

### DESCRIPTION OF SYMBOLS

1, 21, 31, 41 fluid bearing device
2, 22, 32 shaft member
3, 33, 43 hub
4, 34, 44 stator coil
5, 35, 45 rotor magnet
7, 27, 37 housing
7a, 37a inner peripheral surface
8, 81 first bearing sleeve
8a, 81a inner peripheral surface
8a1, 81a1 dynamic pressure generating groove
8b, 81b upper end surface
8b1, 81b1 dynamic pressure generating groove
9, 82 second bearing sleeve
9a, 82a inner peripheral surface
9a1, 82a1 dynamic pressure generating groove
9b, 82c lower end surface
9b1, 82c1 dynamic pressure generating groove
10, 83 spacer
10a, 83a upper end surface
10b, 83b lower end surface
   11, 39 first flange portion
11a, 39b lower end surface
12, 40 second flange portion
12a, 40b upper end surface
D disk
h compression deformation amount
S1, S2, S3 seal space
R1, R2, R11, R12 radial bearing portion
T1, T2, T11, T12 thrust bearing portion

1. A fluid bearing device, comprising:
a housing;
a plurality of bearing sleeves arranged at an interval in an axial direction on an inner periphery of the housing;
a spacer disposed between the bearing sleeves;
a shaft member inserted into inner peripheries of the bearing sleeves; and
radial bearing portions for relatively rotatably supporting the shaft member by a lubricating film of a fluid, which is generated in radial bearing clearances between an outer peripheral surface of the shaft member and inner peripheral surfaces of the bearing sleeves,
wherein the bearing sleeves are fixed to the housing with the spacer being compressed and deformed in the axial direction.

2. A fluid bearing device according to claim 1, wherein the spacer is made of a resin.

3. A fluid bearing device according to claim 1, wherein the bearing sleeves are adhered and fixed to the housing.

4. A fluid bearing device according to claim 1, further comprising:
a flange portion provided to the shaft member and protruding radially outwardly; and
a thrust bearing clearance formed between an axial end surface of the flange portion and an end surface of the bearing sleeve opposed thereto.

5. A fluid bearing device according to claim 4, further comprising a seal space formed between an outer peripheral surface of the flange portion and a surface opposed thereto, for preventing run-off of the fluid in the housing.

6. A fluid bearing device, comprising:
a housing;
bearing sleeves arranged at a plurality of positions in an axial direction on an inner periphery of the housing; and
radial bearing portions for supporting relatively rotatably in a radial direction a shaft to be supported, by a lubricating film of a fluid, which is generated in radial bearing clearances opposed to inner peripheral surfaces of the bearing sleeves, wherein:
the bearing sleeves are fixed to an inner periphery of the housing by an adhesive charged into an adhesion clearance provided to an outer periphery of each of the bearing sleeves; and
the fluid bearing device further comprises a space portion which is provided between the adjacent two bearing sleeves, and which has a width larger than that of the adhesion clearance.

7. A fluid bearing device, comprising:
a housing;
bearing sleeves arranged at a plurality of positions in an axial direction on an inner periphery of the housing;
a spacer member disposed between the adjacent two bearing sleeves; and
radial bearing portions for supporting relatively rotatably in a radial direction a shaft to be supported, by a lubricating film of a fluid, which is generated in radial bearing clearances opposed to inner peripheral surfaces of the bearing sleeves, wherein:
the bearing sleeves and the spacer member are fixed to the inner periphery of the housing by an adhesive charged into an adhesion clearance provided to an outer periphery of each of the bearing sleeves and the spacer member; and
the fluid bearing device further comprises space portions each of which is provided between each of the bearing sleeves and the spacer member adjacent to each other, and each of which has a width larger than that of the adhesion clearance.

8. A fluid bearing device according to claim 6 or 7, further comprising thrust bearing portions for supporting relatively rotatably in a thrust direction the shaft to be supported, by the lubricating film of the fluid, which is generated in thrust bearing clearances opposed to surfaces of the bearing sleeves opposite to surfaces opposed to the space portions.

9. A motor comprising:
the fluid bearing device according to any one of claims 1 to 7;
a stator coil; and
a rotor magnet.
